(19) United States
(12) Patent Application Publication
(10) Pub. No.: US 2026/0009377 A1
(43) Pub. Date: Jan. 8, 2026

(54) Wescott Torque Wheel

(71) Applicant: Richard Robert Wescott, Manchester, NH (US)

(72) Inventor: Richard Robert Wescott, Manchester, NH (US)

(21) Appl. No.: 18/766,445

(22) Filed: Jul. 8, 2024

(51) Int. Cl. F03G 7/10

(52) U.S. Cl. CPC F03G 7/115

(57) ABSTRACT

The present non-provisional patent application introduces the Wescott Torque Wheel, a designed and engineered wheel to neutralize resistance in rotational systems, thereby reducing power input requirements. The invention involves a meticulous design and engineering approach to determine the optimal diameter and weight distribution of the Wescott Torque Wheel to counteract specific resistance encountered in machinery and components. By leveraging the principles of rotational physics and utilizing an efficiently designed Wescott Torque Wheel, the present invention enables the efficient utilization of minimal power sources with self-sustained rotational movement without reliance on traditional energy driven sources. The present invention has far reaching implications for various applications including vehicles, vessels, generators, and industrial machinery.

### BACKGROUND

The history of traditional leverage systems for moving heavy objects dates back thousands of years and has evolved through various civilizations and cultures. The concept of using levers to move heavy objects is based on the fundamental principle of amplifying force to overcome resistance.

The use of levers in ancient times can be traced through civilizations such as ancient Egypt, Mesopotamia, and Greece. Simple machines were developed to aid in construction, transportation, and agriculture. For example, the construction of the pyramids in Egypt is believed to have involved the use of levers and other simple machines to move massive stone blocks into position.

The use of levers over the centuries has been fundamental in achieving mechanical advantage to lift, move, or manipulate objects. A lever is a simple machine consisting of a rigid bar (the lever arm), a fulcrum (the pivot point), and a force supplied to one end of the lever to overcome a resistance at the other end.

Usually the mechanical advantage of a lever depends on the relative distances from the fulcrum to the points where the input force is applied and where the output force is exerted. This is expressed by the formula mechanical advantage (MA)=Length of effort arm/Length of resistance arm. The present invention introduces an innovation of a wheel that exerts leverage and may be fundamental in technologies and trades throughout the world.

Throughout history the understanding and application of leverage have continued to evolve, leading to the development of more sophisticated tools and techniques for moving heavy objects. Innovations and engineering and the scientific understanding of the mechanics have contributed to the refinement and optimization of leverage systems, leading to the creation of diverse types of machinery and equipment used for lifting and moving heavy loads. Such examples include hydraulic jacks, robotic exoskeletons, pulleys, winches, ratchets, socket wrenches, breaker bars, pry bars and pipe wrenches are just a few.

Today, leverage systems are an integral part of various industries, including construction, manufacturing, and transportation where advanced technologies and engineering solutions have further enhanced the efficiency and capabilities of leverage-based systems for moving heavy objects.

The present invention introduces a means of utilizing a circular leverage system that may be utilized to overcome the forces of resistance in a variety of rotational equipment and machinery.

In U.S. patent application Ser. No. 18/445,642 titled ‘Trident Independent Energy Systems,’ this inventor introduced what he had referred to as a ‘modified flywheel.’ It has become apparent that the modified flywheel discussed in the aforesaid patent application is indeed its own patentable invention.

The innovation of the ‘modified flywheel’ discussed in the aforesaid patent application centered around an exemplary 48-inch diameter wheel designed to effectively neutralize 392-foot pounds of resistance presented by an 100,000 watt AC Generator shaft operating under full load. By incorporating a predetermined amount of weight evenly over the outer circumference of the rim of the wheel, a precise calculated rotational torque is achieved, perfectly counterbalancing and exceeding the opposing resistance. The invention, Ser. No. 18/445,642, harnesses the principles of mechanics to optimize performance and enhances machinery operation in countless applications that is capable to be utilized in numerous industries.

The inventor is familiar with three classes of levers based on the positions of the fulcrum, the input force, and the output force. In a first-class lever, the fulcrum is positioned between the input and output forces, such as a seesaw. In a second-class lever, the fulcrum is at one end, with an input force applied at the other end, and output force at the middle, like a wheelbarrow. In a third-class lever, the fulcrum is at one end, the input force is applied at the other end, and the output force is at the middle, such as a broom or shovel. Regardless of the class, levers are used to multiply the input force to overcome a resistance or to cover a greater distance in moving an object. This principle has been applied in countless devices and machines throughout history, from simple tools to complex industrial machinery. The present invention introduces a fourth class of lever, a circular rotational torque lever.

In the present patent application the inventor introduces a novel rotational lever system that incorporates diameter associated with calculated weight distribution, the Wescott Torque Wheel. Said wheel is designed, engineered and manufactured to achieve an efficient counterbalancing and/or neutralization of the load resistance of the shaft of the device and/or component to be driven. By strategically leveraging the Wescott Torque Wheels size and weight distribution, said wheel optimizes the placement of a counterweight system, requiring less weight as the weight is distanced further away from the hub of the Wescott Torque Wheel. This design effectively targets and neutralizes resistance on rotating shafts, representing an advancement in mechanical engineering. Specifically, the larger of the diameter of the rim of a specifically designed, engineered and manufactured Wescott Torque Wheel, the less weight is needed around the outer circumference to balance the system, likened to how a longer lever would need less force to lift an object. The present Invention uses the Wescott Torque Wheel size and weight distribution to optimize the balancing to exceed the load on a shaft of the device being driven. It is an adaptation of a fundamental mechanical principle.

In broad terms, a wheel typically consists of a hub, spokes, and a rim. In the context of the present invention, the hub functions akin to the fulcrum in a traditional lever system. Just as a fulcrum serves as a fixed point for a lever's pivot, the hub in the present invention acts as the pivotal point from which the Wescott Torque Wheel rotates. When external forces are exerted on the wheel, the hub serves as the central pivot point around which said wheel rotates.

In the context of the present invention, the rim serves as the point where focused weight is applied to calculate the necessary force for driving the selected device and/or component. When force is exerted by the rotation of the rim, it results in a rotational effect around the hub. The distance of the rim from the fulcrum (referred to as “hub”) plays a crucial role in determining the mechanical advantage in the resulting rotational motion. Consequently, the rim acts as the point of force application, delivering torque to the hub when the Wescott Torque Wheel is rotating.

In the process facilitated by the present invention, the design of the Wescott Torque Wheel encompassing the rim and spokes, exhibits significant weight-bearing and force-transferring properties. The spokes themselves function as integral components of the lever arm system, contributing to transmission of force from the rim to the hub and thereby playing a crucial role in determining the effective length of the lever arm (Wescott Torque Wheels may be designed and engineered to have spokes, a solid mass or a combination of both). In the context of the present invention, it is accurate to delineate the lever arm as the combined contribution of the wheel's radius and the weight-bearing properties of the spokes. The design and weight distribution of the spokes within the Wescott Torque Wheel system indeed validate their consideration as part of the lever arm mechanism.

By considering scientific principles and using appropriate calculations and analysis, engineers and designers can predict and manage the effects of changes in rotational torque leading to better overall machinery performance and efficiency. Therefore, any changes in the rotational torque, including those resulting from alterations to the Wescott Torque Wheel structure, will have implications for the efficiency and functioning of the connected device and/or component. It is important to carefully consider and analyze these effects when making modifications to devices and/or components.

The calculation process outlined herein provides a systematic approach for determining the rotational torque generated by the Wescott Torque Wheel assembly; specifically, as incremental increases in additional weight increases the diameter of the wheel and/or rim, the rim width remains consistent in the examples provided hereinafter. This method allows for the accurate estimation of rotational torque at the hub, ensuring precise engineering specifications and performance outcomes.

This method involves a step-by-step approach to calculating the rotational torque exerted at the hub of the Wescott Torque Wheel assembly as it undergoes incremental increases in diameter and weight. By systematically adding weight and measuring the resulting changes in rotational dynamics, the calculation process enables the determination of rotational torque with high precision and reliability.

For explanatory purposes only, starting with a base rim diameter of 35 inches, incremental increases of 1 inch are added to the Wescott Torque Wheel assembly by the addition of a specified weight. The weight added at each stage is accurately documented and combined with the existing weight of the wheel assembly to obtain the total weight, representing a specific diameter. The rotational torque is then calculated using the known weight and the formula: Torque=Radius×Force, where the radius corresponds to half of the diameter and the force is the total weight of the rim on the Wescott Torque Wheel. The resulting torque values are recorded for each incremental increase in diameter, providing a comprehensive dataset for analysis and comparison.

By presenting the calculation process for the present invention, the inventor explains this method offering a valuable tool for engineers, designers, and manufactures seeking to optimize rotational performance of the Wescott Torque Wheel assemblies to meet specific operational requirements, enhancing efficiency and safety across diverse industries.

The calculation process outlined herein provides a robust framework for determining rotational torque in Wescott Torque Wheels, offering a systematic approach for enhancing design and performance by parameters. By leveraging this method, practitioners can achieve greater control and accuracy in tailoring Wescott Torque Wheels to meet the demands of complex mechanical systems and applications.

For explanatory purposes only, the inventor discusses the Incremental increase in diameter. Assuming a base rim diameter of approximately 35 inches and a consistent 3″ width, incremental increases of 1″ in weight will be added consecutively for various diameter Wescott Torque Wheels. With each diameter increment, the corresponding weight added, the resulting rotational torque is calculated using the prescribed method. This example will showcase the progressive impact of diameter expansion on the rotational dynamics of the Wescott Torque Wheel. Given the exemplary base rim diameter of the Wescott Torque Wheel is 35″, the circumference of said wheel is approximately 109.9″. For exemplary purposes only, the rim width for the examples hereinafter is 3″. Further, the weight of the exemplary steel used in the present invention (52100 steel) weighs approximately 0.283 lbs. per cubic inch.

Taking the base rim diameter of 35″×3″ Wescott Torque Wheel with a total circumference of approximate 109.9 inches and an approximate rim width of 3″, this totals approximately 329.7 square inches of outer rim surface. Now evenly distributing approximately 329.7 cubic inches of 52100 steel over the outer circumference of said wheel now presents an approximate 1″ steel rim over the circumference of the base rim of the approximate 35″×3″ Wescott Torque wheel. The approximate 329.7 square inches of steel weighs approximately 93.34 lbs. When this configuration of the Wescott Torque Wheel is spun, it will present approximately 136.12-foot pounds of rotational torque, hereafter fprt, at the hub of said wheel (which equals the approximate fprt that an approximate 46.5 horsepower driver would produce). The aforesaid Wescott Torque Wheel now measures approximately 36″×3″ with the addition of the approximate 329.7 cubic inches of steel added to the approximate 35″×3″ base rim diameter, with a circumference of approximately 113.10″.

Taking the aforesaid approximate 36″×3″ Wescott Torque Wheel, now with a total circumference of approximately 113.10″ and an approximate rim width of 3″, this totals approximately 339.3 square inches of outer rim surface. Now evenly distributing approximately 339.3 cubic inches of 52100 steel over the outer circumference of the wheel now presents an approximate 2″ thick steel rim over the circumference of the base approximate 35″×3″ Wescott Torque wheel. The approximate 339.3 square inches of steel weighs approximately 96.06 lbs. When this weight is added to the approximate 93.34 pounds added in paragraph [0022], there is now a combined weight of approximate 189.40 pounds of steel distributed over the outer circumference of the Wescott Torque Wheel. When this configuration of the Wescott Torque Wheel is spun, it will present approximately 284.1 fprt at the hub of said wheel (which equals the approximate fprt that a 97-horsepower driver would produce). The aforesaid Wescott Torque Wheel now measures approximately 37″×3″ with the addition of the approximate 669 cubic inches of steel added to the approximate 35″×3″ base rim surface, with a circumference of approximately 116.34″.

Taking the aforesaid approximate 37″×3″ Wescott Torque Wheel, now with a total circumference of approximately 116.54 inches and an approximate rim width of 3″, this totals approximately 349.02 square inches of outer rim surface. Now evenly distributing approximately 349.02 cubic inches of 52100 steel over the outer circumference of the wheel, now presents an approximate 3″ thick steel rim over the circumference of the approximate base 35″×3″ Wescott Torque Wheel. The approximate 349.02 square inches of steel weighs approximately 99.06 lbs. When this weight is added to the approximate pounds added in paragraph [0023], there is now a combined weight of approximately 288.46 pounds of steel distributed over the outer circumference of the Wescott Torque Wheel. When this configuration of the Wescott Torque Wheel is spun, it will present approximately 445.23 fprt at the hub of said wheel (which equals the approximate fprt that an approximately 152-horsepower driver would produce). The aforesaid Wescott Torque Wheel now measures approximately 38″×3″ with the addition of the approximate 1,018.02 cubic inches of steel added to the approximate 35″×3″ base wheel, with a circumference of approximately 119.38″.

Taking the aforesaid approximate 38″×3″ Wescott Torque Wheel, now with a total circumference of approximately 119.38 inches, and an approximate rim width of 3″, this totals approximately 358.11 square inches of surface. Now evenly distributing approximately 358.11 cubic inches of 52100 steel over the circumference of the wheel, now presents an approximate 4″ thick steel rim over the circumference of the approximate base 35″×3″ Wescott Torque Wheel. The approximate 358.11 square inches of steel weighs approximately 101.70 lbs. When this weight is added to the approximate pounds added in paragraph [0024], there is now a combined weight of approximately 390.16 pounds. When this configuration of the Wescott Torque Wheel is spun, it will present approximately 618.50 fprt at the hub of said wheel (which equals the approximate fprt that an approximate 211.3-horsepower driver would produce). The aforesaid Wescott Torque Wheel now measures approximately 39″×3″ with the addition of the approximate 1,367.04 cubic inches of steel added to the approximate 35″×3″ base wheel, with a circumference of approximately 119.38″.

Noteworthy: The rotational torque calculations for the Wescott Torque Wheel are inherently sensitive to minute changes in the applied force (weight) in said wheel dimensions. Due to the infinite potential combinations of weights and dimensions, the precise foot-pounds of torque values may vary significantly. As such, specific foot-pounds of torque values provided herein are illustrative and intended for exemplary purposes only, recognizing that actual torque values may deviate based on specific parameters of weight and dimensions employed.

As demonstrated above, the examples of varied weights added to the Wescott Torque Wheels circumference highlighted the significant impact on weight distribution on said wheels behavior and performance. As the inventor delves deeper into the dynamics of these weighted wheel configurations it becomes evident that gravitational forces, kinetic energy, and other related forces play a pivotal role in shaping the overall mechanical response of the system. Understanding the interconnected nature of weight, diameter and the resultant forces acting upon the Wescott Torque Wheel not only provides a comprehensive insight into its behavior, but also unveils the intricate relationship between various mechanical elements at play.

By accurately calculating and neutralizing the resistance of a device and/or component being driven, it becomes possible to design and engineer a Wescott Torque Wheel that not only overcomes this resistance effectively, but also optimizes the rotational torque for enhanced efficiency. The balanced and specifically weighted Wescott Torque Wheel, having neutralized the resistance of the driven device and/or component requires only a small fractional and/or minimal horsepower AC and/or DC motor to maintain the desired RPM for both the Wescott Torque Wheel and the driven device and/or component. This engineering approach demonstrates the potential for energy savings and improved performance in a wide range of applications.

A second proposed design of the Wescott Torque Wheel, that will not be embodied, involves a hollow structure on the outer circumference of the Wescott Torque Wheel, which may be likened to resemble a tire. This hollow structure is intended to be filled with small rounded steel and/or lead bearings, beads, pellets, or the likes thereof, and a non-corrosive liquid, which may incorporate baffles for a more controlled and consistent distribution of the liquid and weighted material. Similar to the first Wescott Torque Wheel discussed, adding additional weight to achieve a desired result, this second described Wescott Torque Wheel accomplishes this and is also specifically aimed at increasing rotational torque on the hub while providing a self balancing mechanism for the wheel assembly. The use of a non-corrosive liquid is intended to prevent potential corrosion of the materials, while the incorporated baffles within the hollow structure aims to facilitate even distribution of the weighted materials for optimal self-balancing effects when the Wescott Torque Wheel is spun. When this contrived wheel is stationary, the liquid inside and the weighted materials settle towards the bottom of the said wheel. However, when the wheel starts spinning, forces discussed hereinafter are generated, causing the liquid to move and subsequently displace the weighted material along the circumference of the hollow structure. This dynamic movement of the liquid and weighted material enhances the Wescott Torque Wheels effectiveness by redistributing mass and generating rotational torque. This results in improved performance on the device and/or component being driven, as the rotational force is evenly distributed, reducing power requirements and enhancing overall efficiency in various rotational device and/or component applications.

Similar to the first Wescott Torque Wheel described above, the inventor would recommend that the entire Wescott Torque Wheel described herein, including the hub, spokes and/or solid mass, rim and the defined hollow weighted structure be cast as a single unit for enhanced structural strength and integrity. Similar to the aforementioned Wescott Torque Wheel, the hollow structure design may also be designed and engineered in a variety of sizes to meet the same purposes of the aforementioned Wescott Torque Wheel.

The integral role of the non-corrosive liquid and weighted material in self-balancing is particularly crucial, especially in the context of larger Wescott Torque Wheels, where traditional methods of balancing may become impractical. The use of the non-corrosive and weighted materials to self-balance the wheel may address potential issues related to size and weight, ensuring consistent performance across the entire spectrum of Wescott Torque Wheel dimensions. Note: The inventor would note that the effect of self-balancing a Wescott Torque Wheel described is for a Wescott Torque Wheel that has been specifically designed and engineered for the purposes defined hereinbefore and hereinafter. The effect of self-balancing may not be effective on a wheel not specifically designed and engineered for the specific purpose as outlined above.

The inventor, for exemplary purposes, discusses the influence of the forces and energies on the Wescott Torque Wheel configurations shedding light on their combined effect in determining the systems overall stability and performance.

Centripetal force: Centripetal force is the force that acts on an object moving in a circular path and is directed towards the center of the circular motion. It is responsible for maintaining the objects curved trajectory and preventing it from moving in a straight line. In the case of the Wescott Torque Wheel, the centripetal force is the inward force required to keep the distributed weight moving in a circular path around the hub, this contributing to the generation of rotational torque. In a forthcoming exemplary embodiment, the Wescott Torque Wheel is designed to deliver approximately 63-foot pounds of rotational torque to affectively neutralize the approximate 42-foot pounds of resistance encountered by the driven device (AC generator). In the operation of the Wescott Torque Wheel, a comprehensive interplay of forces comes into play. The centripetal force, resulting from the spinning motion provides the necessary inward forces to maintain the wheels circular trajectory. Moreover, the evenly distributed weight significantly influences the wheels moment of Inertia, thereby resisting changes in the rotational speed.

Centrifugal force: The Wescott Torque Wheel harnesses the principles of centrifugal force to enhance its mechanical functionality. As weight is distributed to the outer circumference of the Wescott Torque Wheel, centrifugal force comes into play. This force, which is result of said wheels rotation, causes the added weight to exert outward inertia. This outward inertia creates torque at the hub, impacting the Wescott Torque Wheels overall rotational behavior. Furthermore, the distribution of weight over the outer circumference of the rim, or within the hollow structure as defined above, significantly influences the centrifugal force experienced by the Wescott Torque Wheel. As the outer weight distribution increases, the centrifugal force intensifies, leading to a greater torque effect at the hub. Understanding this relationship between weight distribution, centrifugal, force, and torque is essential for comprehending the dynamic operation of the Wescott Torque Wheel.

Kinetic energy: Kinetic energy and the Wescott Torque Wheels operation are intimately linked. The rotational motion of the Wescott Torque Wheel is a manifestation of its kinetic energy, which is the energy of motion. When the wheel is set in motion, it's kinetic energy increases as a result of its rotational speed and the distribution of mass around its circumference. As additional weight is added to the outer circumference of the rim, or within the hollow structure as defined above, of the Wescott Torque Wheel, the kinetic energy of the system also increases. This is because the added weight contributes to a higher rotational inertia, amplifying the wheels kinetic energy. Conversely, if the weight is removed, the kinetic energy decreases accordingly. Furthermore, the relationship between kinetic energy and the Wescott Torque Wheel is critical for understanding it's dynamic behavior and its capabilities in various applications. By understanding how the kinetic energy of the Wescott Torque Wheel is influenced by factors such as weight distribution, rotational, speed, and mass, one is able to grasp the fundamental principles behind its functionality.

Gravitational force: In the context of the Wescott Torque Wheel, gravitational force refers to the force of attraction exerted by the Earth of the distributed weight of the Wescott Torque Wheel. This force influences the effective weight distribution and plays a significant role in the dynamics of the rotating system, contributing to the generation and transmission of rotational torque. In the context of the Wescott Torque Wheel, the distributed weight experiences a perceived outward force due to its inertia, resisting changes to its circular path. While centrifugal force is not a genuine force, acknowledging its effects is important in the analysis of the Wescott Torque Wheel and its behavior. The force of gravity is an attractive force exerted by the Earth, drawing objects with mass towards its center. In the context of the Wescott Torque Wheel, the distributed weight is pulled downward by the gravitational forces, influencing its interaction with the ground, its rotation, and its overall behavior.

Being the inventor has explored and explained the intricate forces at play within the Wescott Torque Wheel, he would now like to discuss the systems that may harness and manipulate the energy produced by the Wescott Torque Wheel for practical applications. The seamless transfer of power from the rotational forces of the Wescott Torque Wheel to the intricate mechanisms of clutch systems is critical for the efficient operation of various machinery that may employ a clutch system. Understanding the interplay between these forces and the engineering of clutch systems offers a realm of exploration and innovation when connected with the Wescott Torque Wheel.

The inventor introduces three types of clutch systems that may be incorporated within potential embodiments and/or configurations of the Wescott Torque Wheel: the electromagnetic clutch, the pneumatic clutch, and the hydraulic clutch.

An electromagnetic clutch, also known as a magnetic clutch, works by using electromagnetism to control the transmission of power between the driver and the device being driven. The magnetic clutch has two basic components: an input side (connected to the driver) and an output side (connected to the device being driven). Between these two sides is a magnetic field that is capable of being controlled by applying an electric current. When the magnetic clutch is energised (i.e., an electric current is applied), the magnetic field causes the input and output sides to become “connected,” allowing the transfer of rotational motion from the driver to the driven device. This is known as the clutch being “engaged.” Conversely, when the electric current is removed, the magnetic field diminishes, causing the input and the output sides to become disconnected preventing the transfer of rotational motion, known as the clutch being “disengaged.” This electromagnetic connection provides the advantage of being able to selectively control the engagement and disengagement of the clutch, allowing for independent speed regulation of the driven device without the need for direct mechanical linkage to the driver. This versatility makes electromagnetic clutches suitable for wide range of applications requiring precise speed control and power transmission for embodiments of the present invention. In summary, if the driver is spinning at a consistent RPM, the electromagnetic clutch can engage and disengaging to control the rotational speed of the driven device without affected the driver RPM. By selectively engaging the clutch, the driven device can achieve a speed lower than the driver speed. Essentially, the clutches' ability to engage and disengage the connection point allows it to regulate the speed of the driven device independently from the speed of the driver. This allows for the flexibility to achieve different speeds as required for various anticipated embodiments of the present invention.

A pneumatic clutch is a type of device and/or component that uses air pressure to help two rotating parts, like two shafts. It works like a switch that can smoothly join or separate these parts while they are spinning. This can be useful in various applications to control how power is transferred and help them start, stop, or change speeds smoothly and safely. This system uses a pressurised air system to smoothly engage or disengage the power connection between two spinning parts. When the clutch is engaged, the compressed air applies pressure to the clutch mechanism, allowing it to firmly connect the rotating parts together. This enables power to be smoothly transferred from the driver shaft to the driven shaft, causing the speed to decrease gradually. Conversely, when the clutch is disengaged, the compressed air is released, allowing the clutch mechanism to disconnect the rotating parts smoothly. This separation stops the power transfer, causing the speed to decrease until it reaches zero RPM. So, by controlling when the clutch engages or disengages using compressed air, the speed of the driven shaft can be smoothly controlled, allowing for precise speed changes or stops. This makes the pneumatic clutch a versatile and effective tool for managing power transmission and speed control in various applications. Once engaged, the clutch can effectively transfer power from the driver shaft to the driven shaft, allowing for a steady and controlled rotation, thus helping to maintain a consistent speed as required for the specific application. This can be particularly important in embodiments where variable speeds are critical for optimal operations. By effectively managing the engagement and disengagement of the clutch, the speed control can be maintained contributing to overall operational stability and efficiency. Further, the hydraulic clutch may be used in conjunction with a speed control mechanism, such as a variable speed drive (VSD) and/or a gearbox. The speed control mechanism allows the input speed to be varied, and the pneumatic clutch may be engaged to smoothly transfer this varied speed to the driven shaft.

Finally, a hydraulic clutch can be used to achieve variable speed control for the driven shaft. By manipulating the hydraulic pressure within the clutch system, it is possible to vary the engagement between the driver and the driven shafts, leading to variable and controlled speed for the driven shaft. The hydraulic clutch may consist of a master cylinder, a slave cylinder, hydraulic lines, and the clutch assembly. By adjusting the hydraulic pressure within the system, the engagement force of the clutch may be controlled, which in turn affects the speed and torque transmitted from the driver to the driven shaft. By modulating the hydraulic pressure, one can vary the engagement of the clutch. This directly affects the speed of the driven shaft. When the hydraulic pressure is increased, the clutch will engage more fully, resulting in a higher speed for the driven shaft. Conversely, reducing the hydraulic pressure will disengage the clutch or lessen its engagement, leading to slower speed for the driven shaft. With precise control over the hydraulic pressure, it is possible to achieve variable speeds from zero RPM to many RPM to the driven shaft, as desired. This hydraulic control allows for precise and consistent speed adjustments, enabling the driven shaft to maintain various speed within desired range. In conclusion, a hydraulic clutch can effectively serve the purpose of providing variable and consistent speed control the driven shaft, allowing for regulating the output from 0 RPM to many RPM by manipulating the hydraulic pressure within the clutch system.

The above clutch systems are not to be considered limiting or to be exclusive to any potential exemplary embodiment forthcoming. They are exemplary only of what may be employed and incorporated as a component of a system comprising the Wescott Torque Wheel. In a forthcoming exemplary embodiment, the inventor discusses a potential embodiment of the Wescott Torque Wheel replacing an approximate 1,300 hp marine diesel propulsion engine of a ship. One of the clutch systems, or perhaps none, may be employed within the components of an exemplary embodiment. Therefore, the inclusion of the three different clutch systems is informational only, indicating the versatility of the present invention.

The inventor finds it critical to explore the significant differences between the flywheel and the Wescott Torque Wheel. While the flywheel and the Wescott Torque Wheel both involve rotating components, they each serve distinct functions and operate in different ways.

The flywheels used in industrial machinery typically store mechanical energy rather than actively and consistently providing it. A flywheel, by its nature and definition, serves as a storage device for mechanical energy, and releases energy as needed. Polar opposite, the Wescott Torque Wheel is designed specifically for providing a continuous source of mechanical energy. When energy is imported from a flywheel into a driven machine, such as during the working stroke of a press or punch machine, it is stored in the form of kinetic energy through the rotation of the flywheel. This is stored energy that can be released during the machines operational cycle to provide the required mechanical force or power. Therefore, in most industrial scenarios, the flywheel acts as a mechanical energy storage system helping to smooth out and regulate the energy flow within the machinery. In industrial machinery such as punches and presses, the average flywheel used for mechanical energy storage typically operates at lower RPMs, generally operating at lower speeds, often in the hundreds of RPM's rather than in the thousands.

Flywheels are critical components in various mechanical systems, and it is imperative to emphasize that flywheels should be specifically designed for their intended applications. Not all flywheels are universally suitable for all purposes, and incorrect applications or improper material selection can lead to catastrophic failure. The use of improper material, or operating flywheels beyond their designed capacities can post significant safety risk, including potential structural failure and hazardous incidents. It is essential to adhere to proper engineering guidelines, material selection, criteria, and operational limits when designing and utilizing flywheels to ensure the safety and reliability of mechanical systems.

Opposite the flywheel, the Wescott Torque Wheel with various diameter width and weight configurations is designed to actively leverage forces and torque in a continuous manner, rather than explicitly storing energy for future use. It functions by magnifying and transmitting input forces through rotational motion, allowing for enhanced mechanical advantage and amplification of applied forces. Rather than acting as a storage device for energy, the Wescott Torque Wheel is focused on actively transferring and multiplying rotational force to achieve specific mechanical tasks or effects on a consistent basis. In summary, while a flywheel serves as a means of energy storage and regulation, the Wescott Torque Wheel is geared towards actively and consistently utilizing and manipulating forces through rotational motion in a different way. This distinction highlights the unique function and purpose of the present invention, setting it apart from the conventional flywheel. By using the Wescott Torque Wheel that may be configured in different sizes and weights, as explained hereinbefore and hereinafter, one could indeed calculate the foot pounds of rotational torque at the hub to neutralize the resistance on various shafts in different equipment. This customization can be very beneficial in optimizing the performance of a wide range of machinery.

The inventor collaborated with a metallurgist and others skilled in the various arts comprising the structural aspects of the Wescott Torque Wheel, such as a mechanical engineer in bearings systems, machinist and other engineers. One topic that was unanimous to all consulted was that this is not a do-it-yourself project. As discussed by the inventor and those skilled in the various arts comprising the present invention, it was made clear that as the Wescott Torque Wheel rotates at the various RPMs pertinent to its application, the inertia of the distributed weight exerts centrifugal force on the outer circumference of said wheel creating pressure and stress on the material of the wheel. Understanding the impact of centrifugal force on rotating systems is crucial for designing and engineering components that can withstand the forces involved.

Also, it was discussed by the inventor and those skilled in the art, for exemplary purposes only, that cast iron should not be used in the manufacturing of a Wescott Torque Wheel. Being said wheel may be spinning at approximately 1800 RPM (or more or less), it was unanimously agreed that the centrifugal force experienced during rotation may subject the cast iron to high stress and potential failure. The combination of a large Wescott Torque Wheel diameter and the weight distribution would result in significant forces at said wheels circumference, which may exceed the mechanical limits of regular cast iron. It should be noted that approximately 1800 RPM is only exemplary. Various devices and/or components to be driven will have a variety of RPMs. The working prototype of the present invention is based on a components that are recommended to be driven at approximately 1800 RPM, therefore, approximately 1800 RPM will be the discussed RPM for the majority of discussions, hereinbefore and hereinafter, unless otherwise indicated.

The metallurgist, and the mechanical engineer specializing in bearing systems both unanimously suggested using 52100 steel as a replacement for cast iron or any other material for the Wescott Torque Wheel. As explained, 52100 steel is a high carbon chromium alloy steel known for its excellent wear resistance, high strength, and good fatigue properties. When used in a Wescott Torque Wheel, the 52100 steel may be better suited to withstand the centrifugal forces experience during rotation compared to regular cast iron or any other iron or steel material. It was also mentioned that 52100 is the most common steel used in the bearing systems in airline jet engines, and should be considered to be a viable option for the present invention.

The importance of using the right material in the present invention cannot be overstated. It directly impacts the safety, liability, and performance of the Wescott Torque Wheel and the rotating system. Using a material such as 52100 steel, or the likes thereof, with its superior mechanical properties, mitigates the risk of premature wear, potential failure, and the associated safety hazards. Understanding the material properties and selecting the appropriate material for a specific application of the Wescott Torque Wheel is critical to ensure the durability and integrity of the rotating system. The choice of materials selected in the manufacturing process of a Wescott Torque Wheel is paramount to ensuring the safety and performance of said wheel.

Yet another safety concern discussed in the interdisciplinary consultations was whether the Wescott Torque Wheel should be a one-piece design or multiple piece design. The consultation between the parties explored the potential impact of adding weight onto a rim of a wheel. It was highlighted that adding weight to the rim, regardless of the attachment method, could create a weak spot in the structure. Both a welded and/or bolted attachment present potential vulnerabilities. In consideration of safety, the consensus reached was that a one-piece casting may likely be the safest option for manufacturing. This approach, especially when utilizing strong materials such as 52100 steel or the likes thereof, minimizes weak points and provides a more uniform and reliable structure, aligning with the requirement for safety and reliability in the present inventions application. Therefore, it was concluded that the one-piece cast Wescott Torque Wheel approach will minimize weak points, provide a more consistent structure and meet the necessary safety and reliability standards for Wescott Torque Wheel applications.

To summarize, the main differences and benefits of a Wescott Torque Wheel over an average industrial flywheel lie in their respective designs and functions. The Wescott Torque Wheel, with its flexibility in size and weight configurations, allows for an accurate calculation of foot pounds of torque at the hub to consistently neutralize resistance on various shafts on a variety of different equipment. This adaptability makes it well suited for optimizing the performance of different machines and machinery by providing a consistent and tailored energy output. Conversely, an average flywheel operates as a rotating mechanical device designed to store rotational energy through its inertia. While flywheels are valuable for smoothing out the power delivery in machines and maintaining a consistent speed, they are not customizable to neutralize resistance on different shafts in the same way as the Wescott Torque Wheel is able to do. Therefore, the benefits of the Wescott Torque Wheel over an average flywheel include its ability to be customized and configured to provide consistent energy in diverse machinery applications, compared to the more standardized and limited functionality of an average industrial flywheel.

### PRIOR ART

The inventor has disclosed the present invention in U.S. patent application Ser. No. 18/445,642 titled ‘Trident Independent Energy Systems.’ In said application, the inventor discusses the present invention, referring to the discussed wheel, as a “modified flywheel.”

There is of course, much prior art concerning flywheels, gym weights and the likes thereof, however, the inventor could find no prior art defining in any manner, a wheel specifically engineered and designed to neutralize the resistance in driven devices and/or components by rotational shafts on a consistent basis that eliminate the need for any fuel and/or any currently known alternative energy resources.

### Long Felt Need

A long felt need indeed does exist for an innovation that improves power transfer efficiency and reduces energy consumption. In industries and transportation sectors where power generation and utilization are critical, finding ways to optimize the use of power sources is essential for both economic and environmental reasons. The Wescott Torque Wheel addresses the long felt need for a more sustainable and cost-effective power transfer solution by optimizing power transfer efficiency and reducing energy consumption across various industries and applications. This technology specifically targets the pressing demand for improved energy efficiency in industrial and transportation sectors where power generation and neutralization are critical. By neutralizing rotational resistance, the present invention offers a practical approach to enhancing overall performance and cost savings, thereby fulfilling the long felt need for more efficient power transfer solutions.

In this pivotal error of environmental consciousness and sustainable innovation, the present invention embodies the essence of eco-friendly power generation. The present invention introduces an exemplary embodiment of a self-sustaining and oxygen independent AC generator that can operate reliably in the most challenging environments, whether submerged (in a watertight compartment) in the depths of the ocean or deployed in the vacuum of outer space. This technology not only represents a major leap forward in energy independence, but also addresses the critical need for cleaner and more sustainable power sources. With the escalating environmental impact of oil spills from maritime accidents and the soaring fuel prices, the time is ripe for transformative solutions. The present invention stands at the intersection of necessity and ingenuity, offering a path to mitigate these pressing global challenges. Moreover, the impervious nature of the present invention to solar flares and electromagnetic pulses (EMPs), and other external disruptions ensures unrivaled resilience in the face of potential catastrophic events, thereby safeguarding crucial power generation capabilities in the most extreme conditions. The exceptional characteristics further accentuates reliability and durability of the invention, elevating it in critical applications across diverse domains. Note: The forthcoming exemplified preferred embodiment exemplifies the use of an off-the-shelf AC motor and AC generator, neither having computerized components. Where these components are devoid of advanced electrical control systems or interconnected computerized devices, the exemplified preferred embodiment exhibits a high degrees of resilience to electromagnetic pulses (EMPs) and potential disruptions from solar flares. By eschewing complex electronic interfaces and interconnected systems, the risk of susceptibility to EMP events or solar flares is effectively mitigated. In contrast, should the preferred embodiment incorporate advanced computerized components or interconnected electronic control systems, its vulnerability to EMP events and solar flares would likely increase, as these intricate electronics are more susceptible to disruptions from such phenomena.

Additionally, the significance of such a system extends to its crucial role in addressing natural and man-made disasters, providing vital power generation capabilities of traditional infrastructures that may have been compromised. In military applications, the versatility and reliability of this system presents significant strategic advantages enabling sustained power supply and remote or hostile environments. In the context of village infrastructures and remote communities, the present invention holds the potential to catalyze sustainable development by providing consistent renewable sources to support essential needs and foster local economies.

Although electric energy was the crux of the thought process of the inventor, the potential embodiments reach far beyond generating electric energy. The need for a more efficient and effective propulsion system for vessels and vehicles has been long felt in the transportation sector. The introduction of the Wescott Torque Wheel presents a transformative solution that addresses several long-standing challenges. By harnessing, the principles of rotational torque and leveraging the ability of the Wescott Torque Wheel, it becomes technologically capable of propelling various types of machinery, vessels and vehicles.

Overall, the multifaceted relevance and potential impact of the present invention align closely with the current need for transformative and sustainable solutions in energy generation, disaster response, military applications, and community development. The present invention certainly qualifies as a timely and significant contribution to addressing contemporary challenges. The Wescott Torque Wheel offers that which no other electric and for mechanical energy innovation ever has:

Independence: the present invention offers a self-sustaining and independent, energy generating method, reducing alliance on traditional fuel sources, such as oil, natural gas, propane, diesel fuel, gasoline and nuclear fission:

Environmental impact: by operating without burning fossil fuels, the present invention significantly reduces carbon emissions and environmental pollution, contributing to a cleaner and more sustainable energy solution:

Efficiency: this system provides an efficient method of power generation, whether it be electrical or mechanical, potentially offering higher energy output and reducing energy loss compared to traditional producing methods.

Versatility: unlike solar panels, wind generators and hydroelectric dams, the present invention is not dependent on specific environmental conditions, making it a versatile and reliable source of power generation.

Reduced fuel consumption: when integrated into vehicles, vessels or aircraft, the present invention has potential to reduce overall fuel consumption and may increase overall propulsion efficiency, offering a significant operational cost savings.

Noise and maintenance: the present invention offers quiet operation and reduced maintenance requirements compared to traditional power sources.

Overall, the present invention presents a compelling alternative to traditional power sources offering independence, environmental benefits efficiency, and versatility across various applications.

### Failure of Others

The inventor had a life filled with exploring unconventional ideas and thinking outside the established norms. The present invention may indeed be considered to be outside the realm of traditional mechanical levers; however, it represents an interesting and thought-provoking innovation.

The present invention emphasizes a novel approach of generating rotational torque and may have not been widely explored in traditional mechanical systems. It also cannot be understated that new innovations often involve exploring new possibilities and challenging conventional wisdom. The present invention presented specific challenges to the inventor, while his objective was to pursue a new innovative approach to the traditional and conventional wisdom of others. Indeed, creating a rotational lever compared to traditional methods is thinking beyond the normal realm. The inventor gives much credit to his grandfather, who was also an inventor and had taught the inventor a pioneering spirit of exploring ideas to unleash the potential impact and value that unconditional processes may offer.

The present invention reveals the collaboration, attention to detail and robust construction which are vital aspects that contribute to the reliability and performance of the Wescott Torque Wheel. The use of high strength materials also underscores the commitment to durability and safety, ensuring that the present invention can handle the required forces and function effectively. The inventor would hold that his research indicates others from other countries have explored the use of flywheel systems to provide a result similar to the present invention, however, he can find no-one that has succeeded, many being hoaxes. The inventor also holds that if such an invention were within the world, the world would be well aware of its presence.

### SUMMARY OF INVENTION

The present invention reveals a self-powering system that is engineered to produce targeted rotational torque on a selected device to be driven while also accounting for system efficiency in various operational resistances. Its adaptive design enables integration across diverse industries, including transportation, electricity generation, and industrial machinery. Whether utilized for vehicles, vessels, trains, aircraft or industrial equipment, this multi-faceted innovation offers a comprehensive solution to enhance propulsion, improve energy efficiency and operational advancements across a broad spectrum of applications. Achieving a specific RPM threshold with a specific weight calculated Wescott Torque Wheel is essential to optimizing performance and realizing the full capabilities of this versatile invention.

The present invention represents an advancement in power transmission technology, coupled with the scalability to revolutionize a wide spectrum of applications. The present invention was fine-tuned with collaboration with a multiple decade experienced machinist, a mechanical engineer specializing in bearing systems, and a metallurgist. Several key features of the present invention follow:

Torque calculation: The present invention has unique abilities to apply specific foot pounds of rotational torque to a selected devices to be driven to neutralize the resistance of the shaft of said device being driven. Said resistance may be by the magnetic resistance from an alternator and/or generator, the pressure in a hydraulic system, or resistance in any other form. By knowing the NM (Newton-Meter) of the device being driven, referred to as rotational torque resistance in the present invention, and knowing the space limitations, if any, a Wescott Torque Wheel may be designed, engineered and manufactured to neutralize said NM and/or rotational torque resistance, and additional weight may be engineered onto the Wescott Torque Wheel for enhancing efficiency and performance.

Adaptability and space: The present inventions exceptional adaptability enables the calculation of a wheel with specific dimensions, providing optimal space utilization and customization based on the needs of varied applications. In most cases examined, the Wescott Torque Wheel will take up less space than the fuel holding systems of the fuel powered examples surveyed.

Scalability: Notably, the present invention exhibits exceptional scalability, capable of driving a 2000 AC generator or scaling up to a multi megawatt AC generating system. The present invention is also capable as serving as major components in a complete propulsion electrical systems a ship. This vast scalability offers the present invention the potential to revolutionized power transmission across a wide spectrum of industries.

The interdisciplinary collaboration of the metallurgist, the seasoned machinist, and mechanical engineer specializing in bearing systems has been instrumental in developing the present invention and positioning it as an innovation with profound implications for power transmission solutions.

The present invention, an innovative technology designed to revolutionize power transmission systems, has been developed with a strong emphasis on safety and professional input. This deliberate discussion of material reveals the dedication to safety and reliability, addressing concerns about potential replication attempts and reinforcing the need for professional expertise in working with advanced technologies. By prioritizing safety and incorporating expert recommendations, the present invention sets a new standard, a responsible innovation in power transmission.

This innovative approach signifies a revolutionary leap, as it essentially eliminates the necessity for large, high-powered drivers such as, gasoline, diesel, propane and nuclear fuels, as well as any known alternative energy source, such a hydroelectric dams, solar panels and wind generators. By engineering a balanced weighted Wescott Torque Wheel that effortlessly neutralizes resistance in a driven device, the entire system becomes remarkably efficient. This not only promises substantial energy savings, but also opens the doors to enhanced performance across diverse applications.

Noteworthy: The focus points of the present invention discussed herein focus on the operational aspects of the Wescott Torque Wheel creating sufficient torque to neutralize the resistance on a shaft device and/or component being driven by a large horsepower source of mechanical energy. The inventor with intention, did not delve into the intricacies of any starting system that would crank the Wescott Torque Wheel to its desired RPM. The purpose of the inventor herein is to elaborate on the behavior and characteristics of the Wescott Torque Wheel once it reaches its desired RPM, leaving the details of the starting process aside. The inventor had discovered that numerous off-the-shelf starting systems are available, as well as customized starting systems that may be easily available to utilize with various embodiments of the Wescott Torque Wheel.

### BRIEF DESCRIPTION OF THE DRAWINGS

FIG. 1 shows an exemplary embodiment of the configuration defined and explained as the inventors thought process.

FIG. 2 shows an exemplary embodiment of a Wescott Torque Wheel, wherein said wheel may produce approximately 122.79 foot pounds of rotational torque at the hub of the wheel when rotated.

FIG. 3 shows an exemplary embodiment of the Wescott Torque Wheel, wherein when connected with other components as exemplified hereinafter, may produce approximately 10, 627 watts of usable electricity.

FIG. 4 shows an exemplary embodiment of the Wescott Torque Wheel, wherein when connected with other components as exemplified hereinafter, may produce approximately 4400 foot pounds of rotational torque to propel a vessel.

### DETAILED DESCRIPTION

Aspects of the present invention are disclosed in the following descriptions and related drawings to specific embodiments of the invention. Alternative embodiments may be devised without the departing from the spirit and scope of the invention. Additionally, well-known components of exemplary embodiments of the present invention may not be described in detail or will be omitted so as not to obscure the relevant details of the invention. Further, to facilitate an understanding of the description, discussions of several terms used here in follows.

As used herein, the word “exemplary” means “serving as an example, instance or illustration.” The embodiments described herein are not limiting, but rather exemplary only. It should be understood that described embodiments are not necessarily to be construed as advantageous over other embodiments. Moreover, the terms “embodiments” or “present invention” do not require that all embodiments of the invention include the disclosed features, advantages, or mode of operation. It should further be understood that described embodiments may have multiple integration options and may be highly scalable. It has been contemplated by the inventor that described embodiments may be embodied as a system or systems, product or products, or method, and may assume various and unpredictable forms.

In further exemplary embodiments, not specifically discussed in any detail forthcoming, the present invention may include, however, is not limited to the inclusion of adapters, automated control systems, microprocessors, microcontrollers, logic controllers, timers, switches, diodes, shunts, resistors, mechanical and electrical, regulators, voltage sensors, capacitors, emitters, controllers, semiconductors, valves, transducers, sensors, gauges, meters, relays, solenoids, mechanical and electrical converters, inverters, sprockets, transmissions, shafts, gears, gear reducers, gear increasers, gearboxes, clutch and/or clutch systems, and the likes thereof. All have been contemplated, and it is the intent of the inventor to continue to facilitate a non-ambiguous understanding of the present invention limiting the details to only the basic and necessary information to understanding the Wescott Torque Wheel.

In order to assist in facilitating a clear understanding of the present invention and an attempt of others in the future from entering into linguistic gymnastics on the actual intent of the inventor, he will act at his own lexicographer for the following:

“AC” means for the purposes of the present invention, “alternating current”:

“AC circuit breaker panel,” means for the purposes of the present invention, “an electrical component that is capable of accepting generated electricity from an AC generator and distributing said electricity to other electrical components and/or devices”:

“Approximate and/or approximately” means for the purposes of the present invention when discussing rotations per minute (RPM) “within a difference of 5%”:

“Approximate and/or approximately” means for the purposes of the present invention when discussing the weight of the Wescott Torque Wheel, “the inventors' best calculations. As an example, the crux of the Wescott Torque Wheel is the weight that is evenly incorporated over the outer circumference of the rim. When weight is either added or subtracted from the outer circumference of the rim, it affects rotational torque at the hub. When weight is evenly distributed around the circumference of a rim, the weight furthest from the hub would have the greater effect on the rotational torque than the weight placed on the inner circumference of the rim. This is due to the principle of leverage—the further the weight is from the center of rotation (the hub in this case), the more torque it will exert. Therefore, even a fraction of an inch either toward or away from the hub will affect the rotational torque at the hub. Were a section of the rim to be removed and examined, the removed section would be wedge shaped. Of course, there is more mass in the upper section of the rim than there would on the lower section. Therefore, the weights discussed by the inventor in the present invention are not to be regarded as exact, however, the inventor will provide approximate weights necessary that are sufficient for the operation of the present invention”:

“Approximate and/or approximately” means for the purposes of the present invention, other than discussed hereinbefore, “close to but not exactly, rough amount, estimate, educated guess”:

“Align” means for the purposes of the present invention, “to come into precise adjustment, the proper positioning, with the state of adjustment of components in relation to each other”:

“Balance” means for the purposes of the present invention, “to bring into a state of equipoise, to equal or equalize in weight”:

“Bearings and/or bearing system” means for the purposes of the present invention, “bearings, which rotate in peripheral contact with the number of ball, roller or sleeve bearings; usually contained in a housing”:

“Capable” means for the purposes of the present invention, “having the ability”:

“Component” means for the purposes of the present invention, “a constituent part of the Wescott Torque Wheel” (For the purposes of the present invention, ‘component’ and ‘device’ are to be considered interchangeable):

“Configuration and/or configure” means for the purposes of the present invention, “a stable structural arrangement of components, and/or devices of the Wescott Torque Wheel to achieve a desired result”:

“Device” means for the purposes of the present invention, “a piece of equipment or a mechanism designed to serve a special purpose or to perform a special function” (For the purposes of the present invention, ‘device’ and ‘component’ are to be considered interchangeable)”:

“Dump load” means for the purposes of the present invention, “one or more electrical devices used to dissipate excess power generated by a renewable energy system, such as the present invention, when the electrical storage batteries are employed into the system and are fully charged.”

“Driver” means for the purposes of the present invention, “a mechanical piece for imparting motion to another mechanical piece”:

“Drive shaft and/or shaft” means for the purposes of the present invention, “a balanced and aligned cylindrical bar used to support rotating pieces and transmit power and motion by rotation”:

“Electrical input/output connection points” means for the purposes of the present invention, “a predetermined location by the manufacturer of an electrical component and/or device where electrical connections are to be made”:

“Electrically connected” means for the purposes of the present invention, “connected in a manner that allows for the flow of electricity between two or more electrical components and/or devices to obtain a desired result”:

“Electromagnetic Clutch” means for the purposes of the present invention, “a component that may be disposed between the Wescott Torque Wheel (driver) and the component being driven. The aforesaid clutch may be utilized for engaging and disengaging the component being driven, as well as controlling the speed of the component being driven.”

“Engineered” means for the purposes of the invention, “designed and manufactured for a specific purpose”:

“Ensure” means for the purposes of the present invention, “to make sure, certain, or safe”:

“Fashion” means for the purposes of the present invention, “to form or make with the use of imagination and ingenuity”:

“Fittings” means for the purposes of the present invention, “a small often standard part”:

“Flexible” means for the purposes of the present invention, “having the ability to bend, stretch, or change easily in response to external forces, requirements, or circumstances”:

“Flow” means for the purpose of the present invention, “a transfer of electrical and/or mechanical energy”:

“Frame” means for the purposes of the present invention, “a steel, metal, carbon fiber, composite material or combination of one the more of these materials used as a constructional system or structure that gives shape and strength when assembling components and devices”:

“Generate” means for the purpose of the present invention, “to produce”:

“Hydraulic Clutch” means for the purposes of the present invention, “a component that may be disposed between the Wescott Torque Wheel (driver) and the component being driven. The aforesaid clutch may be utilized for engaging and disengaging the component being driven, as well as controlling the speed of the component being driven.”

“Infinite” means for the purposes of the present invention, “subject to no limitations-infinitely fractional”:

“Lever” means for the purposes of the present invention, “a bar used to induce or compel force,” and is a timeless device used to obtain “leverage”:

“Leverage” means for the purposes of the present invention, “the action of a lever or mechanical advantages gained by it”:

“Like manner, or the like, or the likes thereof” means for the purposes of the present invention, “in a fashion that is similar to the defined, explained and/or exemplified examples”:

“Mechanical” for the purposes of the present invention, “relating to machinery”:

“Mechanically connected” means the purposes of the invention, “a direct or indirect connection made through intermediate parts and components, that may comprise, but not limited to, magnetic connections, welded connections, connections by fasteners (for example, belts, couplings, shafts, bolts, screws, nuts, rivets, quick release connections, latches, sleeves, or the likes thereof”:

“Meticulously” means for the purposes of the present invention, “marked by extreme care in the consideration of details”:

“Operate” means for the purposes of the present invention, “to perform a function or series of functions”:

“Part” means for the purposes of the present invention, “a constituent member of a machine, device, component or other apparatus”:

“Pillow Block Bearing Assembly” means for the purposes of the present invention, “a mounted bearing unit that consists of a housing (or “pillow block”) and a bearing, or bearings that are typically used to provide support for a rotating shaft”:

“Pneumatic Clutch” means for the purposes of the present invention, “a component that may be disposed between the Wescott Torque Wheel (a component of the driver) and the component being driven. The aforesaid clutch may be utilized for engaging and disengaging the component being driven, as well as controlling the speed of the component being driven.”

“Power” means for the purposes of the present invention, “a source or means of supplying electric and/or mechanical energy”:

“Rigid” means for the purposes of the present invention, “devoid of flexibility, excluding the play in bearing systems, couplings, joints, and the likes thereof”:

“Rotate and/or rotated” means for the purposes of the present invention, “rotating swiftly around an axis.” Rotate and/or rotated may be used interchangeably with the words “spun and/or spin.”

“Sleeve” means for the purposes of the present invention, “a tubular part (as a hollow axle or bushing) designed to fit over one or more other parts”:

“Shaft” means for the purposes of the present invention, “a rotating component that transmits power or motion from one device and/or component to another device and/or component”:

“Spun and/or spin” means for the purposes of the present invention, “rotating swiftly around an axis.” Spun and/or spin may be used interchangeably with the words “rotate and or rotated.”

“Starting process” means for the purposes of the present invention, “a method that causes something to begin operating”:

“Stanchion” means for the purposes of the present invention, “an upright bar, post or support system that may be used to support various components in forthcoming exemplary embodiments”:

“Suitable” means for the purposes of the present invention, “adapted for a specific use or purpose”:

“Switch” means for the purposes of the present invention, “a device for making, breaking, or changing the connection in an electrical circuit”:

“Wescott Torque Wheel” means for the purposes of the present invention, “A specific designed and engineered wheel, or series of wheels, that have been designed and engineered to exceed the specific resistance of the device or component to be driven. This involves a careful analysis of the resistance in the component/s to be driven. When the resistance is determined, the Wescott Torque Wheel and/or wheels are able to be designed, engineered and manufactured to provide the appropriate torque generating capacity to overcome any normal resistance in the machinery to be driven, and additional torque may be calculated into the wheel/s in order to provide efficiency of the entire system”:

“Wire” means for the purposes of the present invention, “metal in the form of very flexible thread or slender rod”.

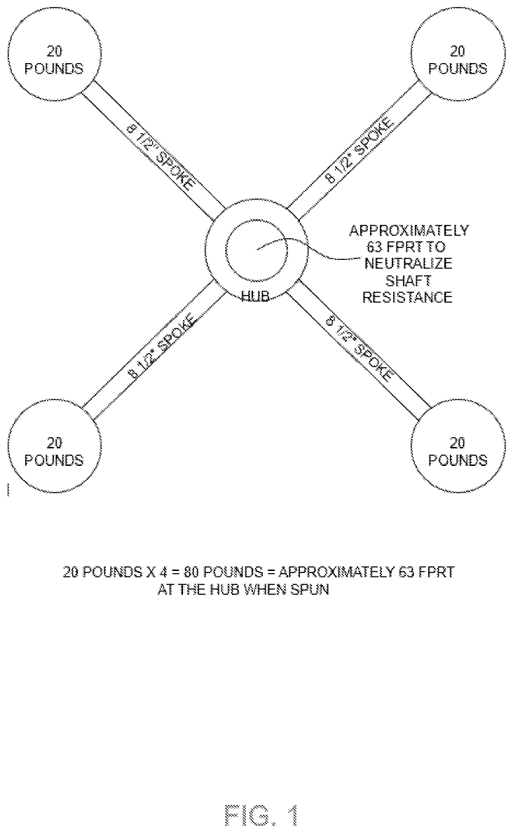

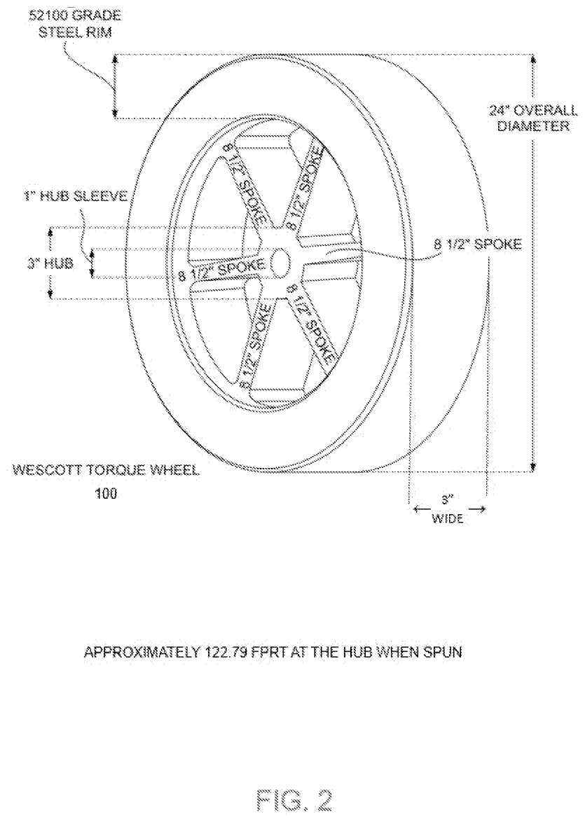

Now referring to exemplary FIG. 1, a concept drawing of an evenly weight distributed configuration which may counteract the approximately 42-foot pounds of resistance on the shaft of the device being driven in exemplary FIG. 2 that may be created within the magnetic field between the stator and the rotor when the exemplary 11,000-Watt AC GENERATOR 102 is at full load, that is to say, when the AC GENERATOR 102 is producing electricity at its full capacity.

As depicted in exemplary FIG. 1, the 20-pound weights attached to the four 8½″-inch spokes present a combined weight of approximately 80 lbs. Because of the approximate 19-inch (including an approximate 2″ hub diameter) distance between the aforesaid weights from the hub, the resultant effect of said weights may apply an approximate 63-foot pounds of rotational torque at the hub when the configuration is spun.

The drawing of exemplary FIG. 1 is used for exemplary purposes only and serves as an example of the thought process of the inventor, converting a traditionally known lever to enhanced rotational lever technology, and does not depict any exemplary embodiment. As has been discussed hereinbefore, the inventor has consulted and confirmed that this contrived configuration could be engineered into a form of an efficient and safe WESCOTT TORQUE WHEEL 100.

Exemplary FIG. 1 illustrates the inventive process of converting four weighted traditional levers into the present invention to generate targeted foot pounds of rotational torque at the hub of said wheel when it is spun. This example showcases the transformation of tradition levers into a circular and/or a rotational level, demonstrating the innovative approach by the inventor. By adapting the levers in this manner, a targeted torque is achieved. The use of levers is a process that has been utilized in varying methods for centuries.

Referring to exemplary FIG. 2, illustrates as exemplary concept drawing of a WESCOTT TORQUE WHEEL 100. The exemplified drawing exemplifies an approximate 24″ in diameter wheel, being approximately 69.08″ in circumference, and being an exemplified 3″ in width.

According to exemplary FIG. 2, concerning the hub assembly, for exemplary purposes only, the hub may be approximately 3″ in diameter, with an exemplified approximate 1″ hub sleeve.

According to exemplary FIG. 2, concerning the spokes of this exemplary embodiment may be approximately 8½″ in length.

According to exemplary FIG. 2, concerning the rim of this exemplified embodiment may be said to be approximately 2″ thick, and approximately 3″ wide.

According to exemplary FIG. 2, by calculation (rim circumference×width), the approximate 69.08 outer circumference of the rim may have an initial approximate 207.24 cubic inches of rim surface, and after the addition of approximately 2″ of exemplified 52100 steel cast as part of the rim of the WESCOTT TORQUE WHEEL 100, the outer circumference of the rim may now be approximately 75.36″ in circumference, and may have an approximately 226.08 cubic inch surface. Further, said rim may now weigh approximately 125.35 pounds.

According to exemplary FIG. 2, as explained hereinbefore, the first inch of 52100 steel on the exemplified WESCOTT TORQUE WHEEL 100 may weigh approximately 61.35 pounds. Thus, when said WESCOTT TORQUE WHEEL 100 is rotated, for explanatory purposes only, would produce approximately 58.79 fprt at the hub of this exemplified embodiment.

According to exemplary FIG. 2, as explained hereinbefore, the second inch of 52100 steel on the exemplified WESCOTT TORQUE WHEEL 100 may weigh an approximately 64.00 pounds. Thus, when said WESCOTT TORQUE WHEEL 100 is spun, for explanatory purposes only, would produce approximately 64.00 fprt.

FIG. 2, as explained hereinbefore, although approximately 125.35 pounds of weight encompasses the rim in this exemplary embodiment, the thickness and weight of the rim must be considered in calculating the rotational torque presented at the hub when the WESCOTT TORQUE WHEEL 100 is spun. The exemplified approximate 125.35 used in a traditional straight level system would produce approximately 125.35 pounds of pressure to be used to take mechanical advantage over an object. The WESCOTT TORQUE WHEEL 100, functioning differently as a rotational level system, using the same weight, would exert approximately 122.79 of fprt to take mechanical advantage over the resistance of a shafts, or the likes thereof.

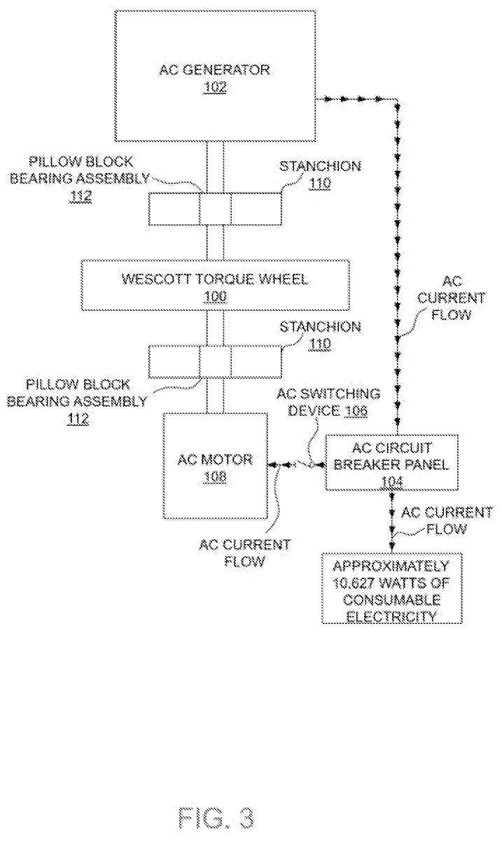

Referring to exemplary FIG. 3, a diagram of a mechanical and electrical flow chart of a preferred embodiment of the WESCOTT TORQUE WHEEL 100 that may produce approximately 10,627 watts of usable electricity.

According to exemplary FIG. 3, for exemplary purposes only, the WESCOTT TORQUE WHEEL 100 may be approximately 19″ in diameter. Said WESCOTT TORQUE WHEEL 100 may have approximately 80 pounds of 52100 steel comprising the rim of the exemplified WESCOTT TORQUE WHEEL 100, where said rim thickness is approximately 2″ and the exemplified width is approximately 3″. The rim diameter discussed, with the addition of the 80 pounds of exemplified 52100 steel comprising the rim will present approximately 63 FPRT on the hub of the WESCOTT TORQUE WHEEL 100 when spun.

According to exemplary FIG. 3, an AC CIRCUIT BREAKER PANEL 104 may be electrically connected by wire to the AC GENERATOR 102.

According to exemplary FIG. 3, an AC SWITCHING DEVICE 106 may be electrically connected between the AC CIRCUIT BREAKER PANEL 104 and AC MOTOR 108 by wire, and may disposed between said AC CIRCUIT BREAKER PANEL 104 and the AC MOTOR 108.

According to FIG. 3, the shaft of an AC MOTOR 108 may be mechanically connected to the WESCOTT TORQUE WHEEL 100. Disposed between said AC MOTOR 108 and WESCOTT TORQUE WHEEL 100 there may be one or more STANCHION 110 assemblies and one or more PILLOW BLOCK ASSEMBLY 112 systems that may provide structural and rotational support for the shaft and/or sleeves connected from the AC MOTOR 108 to the WESCOTT TORQUE WHEEL 100.

According to exemplary FIG. 3, the shaft of the AC GENERATOR 102 may be mechanically connected to the WESCOTT TORQUE WHEEL 100. Disposed between said AC GENERATOR 102 and WESCOTT TORQUE WHEEL 100 there may be one or more STANCHION 110 assemblies and one or more PILLOW BLOCK ASSEMBLY 112 systems that may provide structural and rotational support for the shaft and/or sleeves connected from the AC GENERATOR 102 to the WESCOTT TORQUE WHEEL 100.

According to exemplary FIG. 3, one or more PILLOW BLOCK BEARING ASSEMBLY 112 systems, and one or more STANCHION 110 assemblies may be fashioned and configured by one skilled in the art in a manner where said PILLOW BLOCK BEARING ASSEMBLY 112 systems and one or more STANCHION 110 assemblies may compliment the rotational components, the AC MOTOR 108, the WESCOTT TORQUE WHEEL 100 and the AC GENERATOR 102, and any other components that may be securely and mechanically connected onto or within a frame system and/or onto a platform, depending on the application of said components and/or devices and the configuration of components and/or devices of said application. Such a configuration may allow for AC MOTOR 108, the WESCOTT TORQUE WHEEL 100 and the AC GENERATOR 102 to freely rotate with resistance being from the bearing systems and the air against the discussed components when rotating.

According to exemplary FIG. 3, one or more electrical output connection points of the AC GENERATOR 102 may be wired and electrically connected to one or more input connection points of the AC CIRCUIT BREAKER PANEL 104. Said AC CIRCUIT BREAKER PANEL 104 may be wired and electrically connected to the electrical input connection points of the AC MOTOR 108. As discussed hereinbefore, an AC SWITCHING DEVICE 106 may be disposed in the wiring between said AC CIRCUIT BREAKER PANEL 104 and said AC MOTOR 108. Said AC SWITCHING DEVICE 106 may provide an option between either an opened or closed electrical circuit.

The aforementioned components and/or devices may be configured in a manner where stationary components and devices may have a rigid mechanical connection to a fashioned frame engineered by one skilled in the art, where said components and/or devices may be meticulously aligned to receive the rotating components. Said rotating components may be meticulously aligned and balanced by one skilled in the art.

It may be presumed, for explanatory and exemplary purposes that one or more persons skilled in the various arts comprising the aforementioned components and/or devices has verified that all mechanical and electrical connections are secure, and that a manual rotation or the WESCOTT TORQUE WHEEL 100 was performed and had revealed no rotational obstructions.

Ensuring that the AC SWITCHING DEVICE 106 between the AC CIRCUIT BREAKER PANEL 104 and the AC MOTOR 108 is in the closed position allowing for the flow of electricity, the WESCOTT TORQUE WHEEL 100 may now be spun to approximately 1800 RPM by an undiscussed starting system.

Once said WESCOTT TORQUE WHEEL 100 has achieved a rotational speed of approximately 1800 RPM, said undiscussed starting system may be disengaged. For exemplary and explanatory purposes only, the WESCOTT TORQUE WHEEL 100 now rotating at approximately 1800 RPM which may be mechanically connected to the AC GENERATOR 102 and AC MOTOR 108, which may also be spinning at approximately 1800 RPM, the AC GENERATOR 102 may now be producing approximately 11,000 watts of electricity which may flow to the AC CIRCUIT BREAKER PANEL 104. The AC GENERATOR 102 may be continuously rotating at approximately 1800 RPM do to the approximate 63-foot pounds of rotational torque being applied to the shaft of the AC GENERATOR 102 by the rotation of the WESCOTT TORQUE WHEEL 100, that may be driven by an approximate ½ hp AC MOTOR 108. Said AC MOTOR 108 may consume approximately 373 watts from the AC GENERATOR 102, which may leave approximately 10,627 consumable watts of electricity that the AC CIRCUIT BREAKER PANEL 104 may distribute to end users.

The foregoing exemplified embodiment may be capable of producing approximately 10,627 watts of consumable electricity for an undeterminable period of time, or until either the AC SWITCHING DEVICE 106 between the AC CIRCUIT BREAKER PANEL 104 and AC MOTOR 108 is moved to the opened position which may not allow for the continued flow of electricity to maintain the operation of the AC MOTOR 108, or some other unpredicted mechanical or electrical failure occurs.

Note: The preferred embodiment discussed presents a clear system of energy conversion. The mechanical energy, represented by the rotational torque of the exemplified WESCOTT TORQUE WHEEL 100, is converted into electrical energy through the 11,000-watt exemplified AC GENERATOR 102. As stated, the WESCOTT TORQUE WHEEL 100 rotates at approximately 1800 RPM, the AC GENERATOR 102 responds by producing approximately 11,000 watts of electricity. Approximately 373 watts of said generated electricity is utilized to power the exemplified ½ horsepower AC MOTOR 108, which in turn keeps the WESCOTT TORQUE WHEEL 100 spinning. This process effectively converts the electrical energy back into mechanical energy to maintain the rotation of the WESCOTT TORQUE WHEEL.

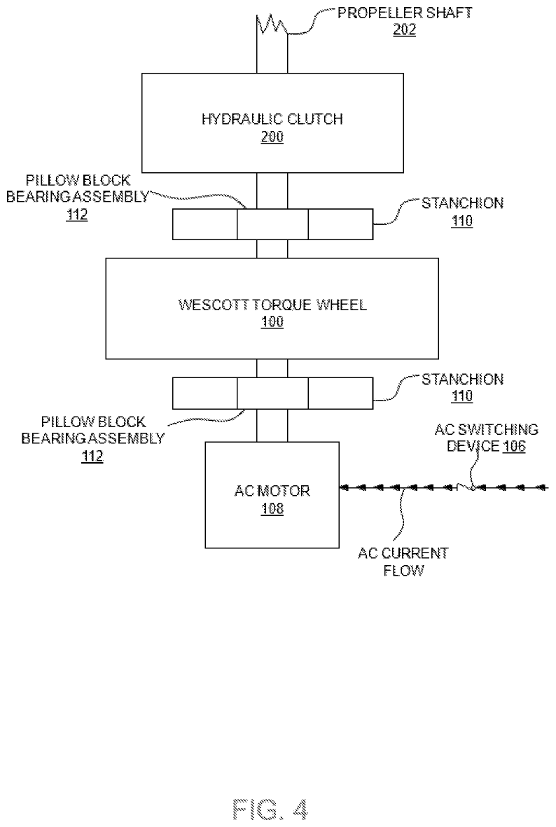

Referring to exemplary FIG. 4, a diagram of a mechanical and electrical flow chart of an exemplary embodiment of a WESCOTT TORQUE WHEEL 100 that may produce approximately 4,400-foot pounds of rotational toque to the PROPELLER SHAFT 202 of a vessel.

According to exemplary FIG. 4, for exemplary purposes only, the WESCOTT TORQUE WHEEL 100 may be approximately 48″ in diameter. Said WESCOTT TORQUE WHEEL 100 may have approximately 2,200 pounds of 52100 steel comprising the rim of the exemplified WESCOTT TORQUE WHEEL 100, where said rim thickness is approximately 3½′″ and the exemplified width is approximately 16″. The rim diameter discussed, with the addition of the 2200 pounds of exemplified 52100 steel comprising the rim will present approximately 4400 FPRT on the hub of the WESCOTT TORQUE WHEEL 100 when spun.

According to exemplary FIG. 4, an undisclosed AC power source is electrically connected by wire to the AC MOTOR 108.

According to exemplary FIG. 4, an AC SWITCHING DEVICE 106 may be electrically connected by wire to the undisclosed AC power source and AC MOTOR 108 and may be disposed between the undisclosed AC power source and AC MOTOR 108. Said AC SWITCHING DEVICE may provide an option between an open or closed electrical circuit.

According to exemplary FIG. 4, the shaft of the AC MOTOR 108 may be mechanically connected to the WESCOTT TORQUE WHEEL 100. Disposed between said AC MOTOR 108 and said WESCOTT TORQUE WHEEL 100 there may be one or more STANCHION 110 assemblies and one or more PILLOW BLOCK ASSEMBLY 112 system/s that may provide structural and rotational support for the shaft and/or sleeves mechanically connected from the AC MOTOR 108 to the WESCOTT TORQUE WHEEL 100.

According to exemplary FIG. 4, the shaft of HYDRAULIC CLUTCH 200 may be mechanically connected to the WESCOTT TORQUE WHEEL 100. Disposed between said HYDRAULIC CLUTCH 200 and WESCOTT TORQUE WHEEL 100 there may be one or more STANCHION 110 assemblies and one or more PILLOW BLOCK ASSEMBLY 112 system/s that may provide structural and rotational support for the shaft and/or sleeves mechanically connected from the input configuration of the HYDRAULIC CLUTCH 200 to the WESCOTT TORQUE WHEEL 100.

According to exemplary FIG. 4, a PROPELLOR SHAFT 202 may be mechanically connected to the output configuration of the HYDRAULIC CLUTCH 200 assembly.

According to exemplary FIG. 4, one or more PILLOW BLOCK BEARING ASSEMBLY 112 system/s, and one or more STANCHION 110 assemblies may be fashioned and configured by one skilled in the art in a manner where said one or more PILLOW BLOCK BEARING ASSEMBLY 112 system/s and one or more STANCHION 110 assemblies may compliment the rotational components, the AC MOTOR 108, the WESCOTT TORQUE WHEEL 100, the HYDRAULIC CLUTCH 200 and the PROPELLOR SHAFT 202, and any others components that may be securely and mechanically connected onto or within the frame system and/or platform, depending on the application of said components and/or devices and the configuration of components and/or devices of said application. Such a configuration may allow for the AC MOTOR 108, the WESCOTT TORQUE WHEEL 100, the HYDRAULIC CLUTCH 200 and the PROPELLOR 202 to rotate freely with resistance being from the bearing systems and the air against the aforementioned components discussed in this embodiment when rotating.

The aforementioned components and/or devices may be configured in a manner where stationary components and/or devices may have a rigid mechanical connection to a fashioned frame engineered by one skill in the art, where said components and/or devices may be meticulously aligned to receive the rotating components. Said rotating components, may be meticulously aligned and balanced by one skilled in the art.

It may be presumed, for explanatory and exemplary purposes that one or more persons skilled in the various arts comprising the aforementioned components and/or devices has verified that all mechanical and electrical connections are secure, and a manual rotation of the WESCOTT TORQUE WHEEL 100 was performed and revealed no rotational obstructions.

Ensuring that the AC SWITCHING DEVICE 106 between the undiscussed AC power supply and the AC MOTOR 108 is the closed position, allowing for the flow of electricity, the WESCOTT TORQUE WHEEL 100 may not be spun to approximately 1800 RPM by an undiscussed starting system.

When said WESCOTT TORQUE WHEEL 100 has achieved a rotational speed of approximately 1800 RPM, said undiscussed starting system may be disengaged. For explanatory and exemplary purposes only, the WESCOTT TORQUE WHEEL 100 now rotating at approximately 1800 RPM which may be mechanically connected to the HYDRAULIC CLUTCH 200 and the PROPELLOR SHAFT 202, the WESCOTT TORQUE WHEEL 100 may be producing approximately 4400 FPRT to the HYDRAULIC CLUTCH 200 which may rotate the PROPELLOR SHAFT 202 to its desired RPM. The HYDRAULIC CLUTCH 200 may be continuously receiving the 4400 FPRT from the WESCOTT TORQUE WHEEL 100, that may be continuously driven by a minimal horsepower AC MOTOR 108. Said AC MOTOR 108 may consume a fraction of energy compared to a traditional driver for such a HYDRAULIC CLUTCH 200 assembly and PROPELLOR SHAFT 202.

For exemplary and explanatory purposes only, the WESCOTT TORQUE WHEEL 100 that may now be rotating at approximately 1800 RPM and that may be producing approximately 4400 FPRT which may be mechanically connected to the PROPELLER SHAFT 202 through the HYDRAULIC CLUTCH 200 components, which may also be spinning at approximately 1800 RPM, said propeller shaft may now have its rotational speed controlled by said HYDRAULIC CLUTCH 200 while the WESCOTT TORQUE WHEEL 100 continues to spin at a continuous 1800 RPM.

The foregoing exemplified embodiment may be capable of producing approximately 4400 FPTR at approximately 1800 RPM for an undeterminable period of time, or until the AC SWITCHING DEVICE 106 Disposed between the undiscussed AC power source and the AC MOTOR 108 is moved to the open position, which may not allow for the continued flow of electricity to maintain the operation of the AC MOTOR 108, or some other unpredicted, mechanical or electrical failure occurs.

What is claimed is:

1. A weighted wheel configuration, referred to as the Wescott Torque Wheel, wherein said wheel configuration is precision-designed and engineered for generating a targeted amount of rotational torque on the hub of said wheel that will mitigate and counteract mechanical and other factored resistance encountered during the typical operation of a variety of rotational components and/or devices when said wheel and said rotational components have been connected to one another as described and defined hereinbefore.

2. The Wescott Torque Wheel configuration of claim 1, wherein said wheel configuration is designed and engineered to convert rotational energy into both mechanical and electrical energy, said wheel assembly comprising:
a) A hub;
b) Spokes, or a solid mass;
c) A rim.

3. The Wescott Torque Wheel configuration of claim 1, wherein the rotational torque at the hub is influenced by both the diameter of the Wescott Torque Wheel and the weight distribution comprising the rim of said wheel, with the fixed weight distribution resulting in different torque values when applied to wheels of varying diameters.

4. The Wescott Torque Wheel configuration of claim 1, wherein said wheel is capable of being manufactured in hole or in part but, not limited to by one of the following methods;
a) Casting: wherein the Wescott Torque Wheel is formed by pouring molten material into a mold to produce the desired shape, resulting from the cost-effective and versatile manufacturing process;
b) Machining: wherein the Wescott Torque Wheel is produced by removing material from a solid workpiece, using cutting tools, ensuring precise dimensional control, and surface finish;
c) Forging: wherein the Wescott Torque Wheel is created through the application of compressive force to shape the material, resulting in a strong and durable component, suitable for energy conversion applications;
d) 3-D Printing: wherein the Wescott Torque Wheel is additively manufactured by depositing material layer by layer based on a digital model, allowing for the production of intricate geometries and customized designs; and
e) Extrusion: wherein the Wescott Torque Wheel is formed by forcing the material through a die to produce a linear profile with consistent cross-sections, suitable for creating cylinder or profile components with high precision.

5. The Wescott Torque Wheel configuration of claim 1, wherein the hub, spokes and rim are engineered and manufactured using the following methods:
a) Separate components: wherein the hub, spokes or solid mass, and rim are produced as individual components and assembled together to form the Wescott Torque Wheel assembly, allowing modular construction and ease in maintenance; and
b) Cast as one individual component: wherein, the hub, spokes or solid mass, and rim are integrally cast as a single monolithic component, providing structural integrity and potentially reducing assembly and alignment processes.

6. The Wescott Torque Wheel configuration of claim 1, wherein the design and engineering of said wheel includes additional weight strategically engineered to be incorporated into the rim during manufacturing, above and beyond the weight necessary to neutralize the operational resistance of the driven device and/or component to augment rotational torque, enhancing the efficiency of the driven device and/or component, enabling it to overcome various resistances, including, but not limited to bearing systems, air resistance, mechanical friction encountered during operation, and increased friction as the components of the driven device and/or component begin to wear.

7. The Wescott Torque Wheel configuration of claim 1, wherein said wheel structure is comprised of one or more materials, including, but not limited to, alloys, rubber, plastics, aluminum, carbon fiber, steel alloys, or other suitable materials to accommodate varying operational requirements and environmental conditions.

8. The Wescott Torque Wheel configuration of claim 1, wherein the rotation of said wheel is sustained by an AC and/or DC motor capable of accommodating a range of Wescott Torque Wheel weights, wherein said electric motor is configured to maintain continuous rotation of the Wescott Torque Wheel, wherein the electric motor is selectively scalable to a higher horsepower rating to accommodate heavier Wescott Torque Wheel weights exceeding a predetermined threshold, and to a lower fractional horsepower rating for lighter Wescott Torque Wheel configurations.

9. The Wescott Torque Wheel of claim 1, wherein said wheel is adaptable to a range of rotational speeds to accommodate and efficiently integrate with various rotational devices and/or components to be driven, thereby providing versatility across different operational requirements without limitation to specific RPM values.

10. The Wescott Torque Wheel of claim 1 comprising a hub, spokes, or solid mass, and a rim, wherein said wheel is designed and engineered to incorporate a specific calculated weighted rim integrated at a predetermined distance from the hub, which is determined by the length of the spokes or the dimensions of the solid mass, to neutralize the resistance encountered during operation of the device and/or component being driven that has been connected to the hub of the Wescott Torque Wheel.

11. The Wescott Torque Wheel configuration of claim 1, wherein said wheel is capable of connections to the device and/or component being driven, and the AC and/or DC motor driver by the following means, including, but not limited to, a rigid shaft connection, a flexible shaft connection, a pulley and belt system, a gearing system, a magnetic coupling system, a hydraulic coupling system, a pneumatic coupling system, a direct drive system, a friction drive system, a chain drive system, and a mechanical drive system.

12. The weighted wheel configuration discussed hereinbefore, referred to as the Wescott Torque Wheel, may be designed, engineered and manufactured to have a hollow component incorporated into said wheel, wherein said hollow component is capable of containing a non-corrosive liquid and weighted materials as discussed hereinbefore, that is capable of being designed, engineered and manufactured is the same manner as the Wescott Torque Wheel discussed above, and providing the same benefits as the weighted Wescott Torque Wheel as discussed hereinbefore, with the additional benefit of providing a self-balancing aspect, with said wheel assembly comprising:
a) A hub;
b) Spokes, or a solid mass;
c) A rim; and
d) A hollow structure as defined and described hereinbefore, capable of containing a variety of small solid mass bearings, or the likes thereof, and a non-corrosive liquid that facilitates the distribution of the weighted materials to their desired positions within the hollow structure, when the configuration of this described Wescott Torque Wheel is spun.

13. The Wescott Torque Wheel configuration of claim 12, wherein the rotational torque at the hub is influenced by both the diameter of the Wescott Torque Wheel and the weight distribution of the non-corrosive liquid and weighted materials within the hollow structure of said wheel, with the targeted weight distribution resulting in different torque values when applied to wheels of varying diameters.

14. The Wescott Torque Wheel configuration of claim 12, wherein said wheel is capable of being manufactured in hole or in part but, not limited to by one of the following methods;
a) Casting: wherein the Wescott Torque Wheel is formed by pouring molten material into a mold to produce the desired shape, resulting from the cost-effective and versatile manufacturing process;
b) Machining: wherein the Wescott Torque Wheel is produced by removing material from a solid workpiece, using cutting tools, ensuring precise dimensional control, and surface finish;
c) Forging: wherein the Wescott Torque Wheel is created through the application of compressive force to shape the material, resulting in a strong and durable component, suitable for energy conversion applications;
d) 3-D Printing: wherein the Wescott Torque Wheel is additively manufactured by depositing material layer by layer based on a digital model, allowing for the production of intricate geometries and customized designs; and
e) Extrusion: wherein the Wescott Torque Wheel is formed by forcing the material through a die to produce a linear profile with consistent cross-sections, suitable for creating cylinder or profile components with high precision.

15. The Wescott Torque Wheel configuration of claim 12, wherein the hub, spokes and rim and hollow structure are engineered and manufactured using the following methods:
a) Separate components: wherein the hub, spokes or solid mass, rim and hollow structure are produced as individual components and assembled together to form the Wescott Torque Wheel assembly, allowing modular construction and ease in maintenance; and
b) Cast as one individual component: wherein, the hub, spokes or solid mass, and rim are integrally cast as a single monolithic component, providing structural integrity and potentially reducing assembly and alignment processes.

16. The Wescott Torque Wheel configuration of claim 12, wherein the design and engineering of said wheel includes additional weight strategically engineered to be placed within the hollow structure during manufacturing, above and beyond the weight necessary to neutralize the operational resistance of the driven device and/or component to augment rotational torque, enhancing the efficiency of the driven and/or component, enabling it to overcome various resistances, including, but not limited to bearing systems, air resistance, mechanical friction encountered during operation, and increased friction as the components of the driven device and/or component begin to wear.

17. The Wescott Torque Wheel configuration of claim 12, wherein said wheel structure is comprised of one or more materials, including, but not limited to, alloys, rubber, plastics, aluminum, carbon fiber, steel alloys, or other suitable materials to accommodate varying operational requirements and environmental conditions.

18. The Wescott Torque Wheel configuration of claim 12, wherein the rotation of said wheel is sustained by an AC and/or DC motor capable of accommodating a range of Wescott Torque Wheel weights, wherein said electric motor is configured to maintain continuous rotation of the Wescott Torque Wheel, wherein the electric motor is selectively scalable to a higher horsepower rating to accommodate heavier Wescott Torque Wheel weights exceeding a predetermined threshold, and to a lower, fractional horsepower rating for lighter Wescott Torque Wheel configurations.

19. The Wescott Torque Wheel of claim 12, wherein said wheel is adaptable to a range of rotational speeds to accommodate and efficiently integrate with various rotational devices and/or components to be driven, thereby providing versatility across different operational requirements without limitation to specific RPM values.

20. The Wescott Torque Wheel of claim 12 comprising a hub, spokes, or solid mass, rim, and hollow structure, wherein said wheel is designed and engineered to incorporate a specific calculated non-corrosive liquid and weighted material to be integrated at a predetermined distance from the hub, which is determined by the length of the spokes or the dimensions of the solid mass, to neutralize the resistance encountered during operation of the device and/or component being driven that has been connected to the hub of the Wescott Torque Wheel.

21. The Wescott Torque Wheel configuration of claim 12, wherein said wheel is capable of connections to the device and/or component being driven, and the AC and/or DC motor driver by the following means, including, but not limited to, a rigid shaft connection, a flexible shaft connection, a pulley and belt system, a gearing system, a magnetic coupling system, a hydraulic coupling system, a pneumatic coupling system, a direct drive system, a friction drive system, a chain drive system, and a mechanical drive system.
